(19) United States
(12) Patent Application Publication
(10) Pub. No.: US 2009/0074004 A1
(43) Pub. Date: Mar. 19, 2009

(54) Back-off-state assignment for channel throughput maximization of wireless networks

(75) Inventor: Dilip Sarkar, Coral Gables, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: University of Miami a Florida non-profit Corporation, Coral Cables, FL (US)

(21) Appl. No.: 11/918,773

(22) PCT Filed: Mar. 15, 2006
(86) PCT No.: PCT/US2006/009454

§ 371 Date: Oct. 18, 2007

Related U.S. Application Data
(60) Provisional application No. 60/662,331, filed on Mar. 15, 2005.

(51) Int. Cl. H04L 12/413

(52) U.S. Cl. 370/448

(57) ABSTRACT

A method, system and computer program product for maximizing throughput by assigning nodes to the states of a given back-off level non-uniformly when experiencing channel contention. The back-off-state assignment process of the present invention can provide a novel and non-obvious assignment method, system and apparatus for assigning a node at back-off state s(i, k) in order to ensure fairness among nodes and to reduce channel contention. To achieve the foregoing effect, the back-off state assignment process of the present invention can set a back-off counter value for a given node to a randomly selected higher value with a greater probability.

### BACKGROUND OF THE INVENTION

1. Statement of the Technical Field

The present invention relates to the transmission of radio signals in wireless networks, and more particularly to managing back-off state assignment in a wireless network environment

2. Description of the Related Art

Modern communications has witnessed the rapid popularization and proliferation of wireless networking technologies. The advent of the wireless network has given rise to new paradigms in personal and business computing which permit a new found mobility not previously available to the end user. Given the mobility associated with wireless computing, to ensure common, compatible, and interoperable technologies, the Institute of Electrical and Electronic Engineers (IEEE) standards working groups have formalized several Medium Access Control (MAC) layer and Physical (PHY) layer specifications. The MAC and PHY layer specifications are collectively known as the IEEE 802.11 standard.

According to the IEEE 802.11 standard, the MAC layer can include a fundamental access method suitable for contention services, the Distributed Coordination Function (DCF), and an optional centralized access method required for contention-free services, known as the Point Coordination Function (PCF). A Basic Service Set (BSS)—a group of wireless terminals under the control of the DCF or the PCF—can either be an independent network or part of an infrastructure network, in which an Access Point (AP) links the wireless terminals to the backbone network, therefore allowing communication between terminals on different BSSs.

In DCF mode, the wireless network can be in a Contention Period (CP) and the stations, otherwise known as nodes, can compete in order to gain access using the Carrier Sense Multiple Access/Collision Avoidance (CSMA/CA) protocol. In CSMA/CA, a node having a packet queued for transmission can monitor the transmission channel. Prior to transmitting the packet, the node can wait until the transmission channel has been idle for a time period equal to the distributed inter-frame space (DIFS).

A node operating in the DCF mode can choose from two channel access methods. In the basic access CSMA/CA method, the node can transmit its data packets without regard for the environment of the receiving node. Consequently, packets may not be delivered to the destination because of interference from another node near the receiving node, but away from the sending node. This phenomenon, known as the “hidden node” problem, increases as the node density, channel access rate, or both increases.

To overcome the hidden node problem a sender initially transmits a shorter request to send (RTS) packet and waits for a clear to send (CTS) packet. This DCF channel access mechanism, is known as RTS/CTS mechanism, provides higher successful data communication rates than the basic mechanism when packet sizes are large compared to RTS/CTS packets. After receiving a RTS or data packet a node waits for a short inter-frame space (SIFS) period and then transmits a CTS or an acknowledgment (ACK) packet, respectively.

Both basic and RTS/CTS mode of operations are based on the CSMA/CA access method and a random back-off mechanism, if necessary. A node is referred to as idle if it has no packet to transmit. An idle node remains in the idle state if the node does not receive a packet in a slot time. On receiving a data packet while in the idle state, a node enters the back-off disabled mode if no other node access the channel for a DIFS period. Otherwise the node enters into the back-off mode and moves to a state s(0, k) whose duration k is a uniformly distributed integer between 0 to (wₘᵢₙ−1) and is stored in a counter referred to as a back-off counter.

A node in a back-off state monitors channels for activity, and decrements the back-off counter if the channel is idle for a DIFS period. As soon as the back-off counter reaches zero, the node can attempt transmission of the packet. If the transmission is successful, the node enters into one of the two possible states; if it has no packet to transmit, the node enters into the idle state I. Otherwise the node enters into the state s(0, k) by choosing a value of k as described above.

Notably, there are m+1 possible back-off levels which are leveled from zero to m. The size of contention window (CW) at the level i, 0<i<=m, is wᵢ=2wᵢ₋₁=2^{l}wₘᵢₙ, where

w₀=wₘᵢₙ. If a node successfully transmits a data packet from the state s(i,0) at back-off level i, the node moves to one of the two possible states: (1) if the node has a data packet to transmit the node moves to state s(0, k) by choosing a value of k as described above; or (2) the node moves to the state I. If a node fails to successfully transmits a data packet from the state s(i, 0) because of a channel contention, then chooses one of the two steps based upon the current back-off level i.

Specifically, if i<m, the node doubles its contention window size to wᵢ₊₁ (=2wᵢ) from wᵢ and moves to a state s(i+1, k), whose duration k is a uniformly distributed integer between 0 to (wᵢ₊₁−1) and is stored in the back-off counter; otherwise, (i=m), the size of contention window is maximum and the node does not change contention window size (and back-off level) but moves to a back-off state s(m, k) by choosing a value of k as described earlier.

The IEEE 802.11 standards recommend that when a node is assigned to a state s(i, k) in the back-off level i, the value of k is selected from a uniform distribution, that is, the probability of being in the state s(i,k) is defined by the equation

$${p}_{i , k} = \frac{1}{{ω}_{0} {2}^{i}} .$$

Note that the value of p_{i,k} does not depend on k, but only on the back-off level i. When two or more nodes from state s(i−1, 0) collide in channel access, the uniform distribution can distribute the nodes to any of the states s(i, 0) to s(i, w₀2ⁱ−1) in the back-off level i. However, to do so can cause unfairness in queuing nodes for transmission while also increasing the likelihood of a subsequent collision.

Specifically, it is possible that a later node experiencing a collision can be placed in a back-off state in advance of a prior node experiencing a collision, such that the later node can access the channel before the prior node. Moreover, given the linearly increasing probability of a collision occurring as the counter in a back-off state decreases bringing a node closer to a transmission state, there will be a higher probability of another node also attaining the same state resulting in a higher probability of a collision.

### SUMMARY OF THE INVENTION

Embodiments of the present invention address deficiencies of the art in respect to back-off state assignment and provide a novel and non-obvious back-off-state assignment method, system and computer program product. In one embodiment of the invention, a back-off-state assignment process can assign a node at back-off state s(i, k) in order to ensure fairness among nodes and to reduce channel contention. To achieve the foregoing effect, the back-off state assignment process of the present invention can set a back-off counter value for a given node to a higher initial value with a greater probability than that the existing assignment method.

In an aspect of the embodiment, a method for assigning a node at a back-off state where the back-off counter has a higher value can include, responsive to an attempt to transmit data, detecting a collision in a transmission channel for the data; computing a back-off counter value using a non-uniform probability distribution function; and, assigning the node to the back-off state according to the computed value. The computing step can include the step of computing a back-off counter value k satisfying the following probability distribution function.

$${p}_{i , 0} = \frac{c}{{ρ}^{{ω}_{0} {2}^{i} - 1}} for i ∈ ( 0 , m )$$

$${p}_{i , k} = \frac{c}{{ρ}^{{ω}_{0} {2}^{i} - k}} for k ∈ ( 1 , {ω}_{0} {2}^{i} - 1 ) , i ∈ ( 0 , m )$$

where ρ>1, and c is the normalization constant, and is obtained from

$${\sum }_{k = 0}^{{ω}_{0} {2}^{i} - 1} {p}_{ik} = 1$$

The assignment step, in turn, can include the step of assigning the node to a back-off state associated with the above probability distribution function that minimize collision and maximize channel throughput.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a wireless network configured for maximized throughput by way of a non-uniformly assigned back-off state for nodes experiencing channel contention; and,

FIG. 2 is a flow chart illustrating a process for maximizing throughput by way of a non-uniformly assigned back-off state for nodes experiencing channel contention.

### DETAILED DESCRIPTION OF THE INVENTION

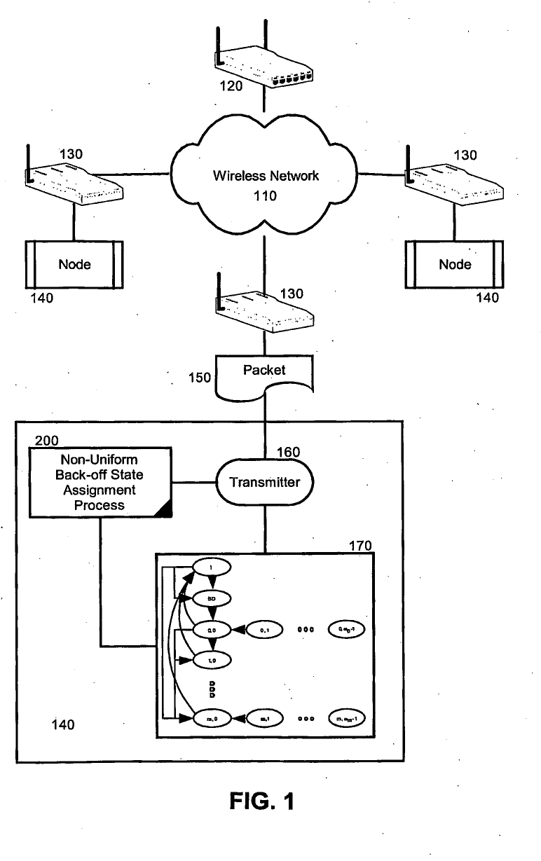

FIG. 1 is a schematic illustration of a wireless network configured for maximized throughput by way of a non-uniformly assigned back-off state for nodes experiencing channel contention. As shown in FIG. 1, the wireless network 110 can include a wireless access point 120 communicatively linking together one or more nodes 140 by way of corresponding wireless radios 130. Each of the nodes 140 can include a transmitter 160 configured to transmit packets 150 intended for transmission across the wireless network 110. Notably, the transmitter 160 can be operably coupled to a non-uniform back-off state assignment processor 200.

Responsive to the detection of a collision, the non-uniform back-off state assignment processor 200 can manage the assignment of the node 140 to a specified back-off state represented in a logical hierarchy 170 of back-off states. Based upon the nodal placement within the hierarchy 170, the node 140 can await a subsequent opportunity to attempt transmission of the packet 150.

More specifically, in accordance with the present invention, when a collision is detected when attempting to transmit the packet 150 in the node 140, the probability of assigning the node 140 to a back-off state s(i, k) in the hierarchy 170 can be computed such that the following probability distribution function is satisfied:

$${p}_{i , 0} = \frac{c}{{ρ}^{{ω}_{0} {2}^{i} - 1}} for i ∈ ( 0 , m )$$

$${p}_{i , k} = \frac{c}{{ρ}^{{ω}_{0} {2}^{i} - k}} for k ∈ ( 1 , {ω}_{0} {2}^{i} - 1 ) , i ∈ ( 0 , m )$$

where ρ>1, and c is the normalization constant, and is obtained from

$${\sum }_{k = 0}^{{ω}_{0} {2}^{i} - 1} {p}_{ik} = 1.$$

Utilizing the foregoing function, a higher value can be set for the back-off counter responsive to a collision with a higher probability than that which would be expected from the IEEE 802.11 standard back-off state assignment methodology. Consequently, the probability of a subsequent collision can be reduced and fairness among all nodes 140 can be enhanced.

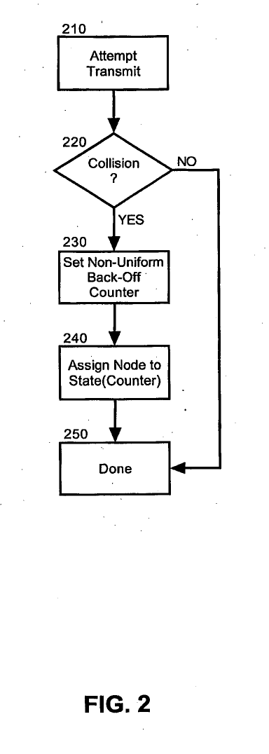

In further illustration, FIG. 2 is a flow chart illustrating a process for maximizing throughput by way of a non-uniformly assigned back-off state for nodes experiencing channel contention. Beginning in block 210, an attempt to transmit a packet can be detected. If the attempted transmission results in a collision as determined in decision block 220, in block 230, the back-off counter can be set non-uniformly so as to produce a higher probability of a higher counter value in order to decrease the probability of a subsequent collision while ensuring fairness among nodes in the wireless network. Subsequently, in block 240 the node can be assigned to the back-off state reflected by the counter and in block 250 the process can terminate.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A back-off state assignment method comprising the steps of:
responsive to an attempt to transmit data, detecting a collision in a transmission channel for the data;
computing a back-off counter value using a non-uniform probability distribution function; and,
assigning the node to a back-off state according to the computed back-off counter value.

2. The method of claim 1, wherein the computing step comprises the step of computing a back-off state k satisfying the following probability distribution function.
$${p}_{i , 0} = \frac{c}{{ρ}^{{ω}_{0} {2}^{i} - 1}} for i ∈ ( 0 , m )$$
$${p}_{i , k} = \frac{c}{{ρ}^{{ω}_{0} {2}^{i} - k}} for k ∈ ( 1 , {ω}_{0} {2}^{i} - 1 ) , i ∈ ( 0 , m )$$
where ρ>1, and c is the normalization constant, and is obtained from
$${\sum }_{k = 0}^{{ω}_{0} {2}^{i} - 1} {p}_{ik} = 1.$$

3. The method of claim 1, wherein the assignment step comprises the step of assigning the back-off counter value to a node for maximizing transmission probability.

4. A back-off state assignment system comprising:
a memory system for data storage;
a processor programmed to compute a back-off counter value satisfying a non-uniform probability distribution function; and,
a hierarchy of back-off states configured to accommodate nodes in selected back-off level of the back-off states according to corresponding computed back-off counter value for a node.

5. The system of claim 4, wherein the processor and the corresponding program compute back-off counter value satisfying a non-uniform probability distribution function having the form
$${p}_{i , 0} = \frac{c}{{ρ}^{{ω}_{0} {2}^{i} - 1}} for i ∈ ( 0 , m )$$
$${p}_{i , k} = \frac{c}{{ρ}^{{ω}_{0} {2}^{i} - k}} for k ∈ ( 1 , {ω}_{0} {2}^{i} - 1 ) , i ∈ ( 0 , m )$$
where ρ>1, and c is the normalization constant, and is obtained from
$${\sum }_{k = 0}^{{ω}_{0} {2}^{i} - 1} {p}_{ik} = 1.$$

6. The system of claim 4, wherein the memory system and processor are disposed in a node among the nodes and communicatively linked to others of the nodes by way of a wireless radio.

7. The system of claim 6, wherein the nodes are communicatively linked together in a wireless network by a wireless access point, each of the nodes comprising a transmitter configured to transmit packets intended for transmission across the wireless network.

8. The system of claim 7, wherein each transmitter is operably coupled to a non-uniform back-off state assignment processor comprising program code enabled to manage the hierarchy of back-off states.

9. A machine readable storage having stored thereon a computer program for computing and assigning a back-off state to a node in a wireless network transmission system, the computer program comprising a routine set of instructions which when executed by a machine causes the machine to perform the steps of:
responsive to an attempt to transmit data, detecting a collision in a transmission channel for the data;
computing a back-off level and back-off counter value for a node; and,
assigning a node to a back-off state according to the computed back-off level and back-off counter value satisfying a non-uniform probability distribution function.

10. The machine readable storage of claim 9, wherein the computing step comprises the step of computing a back-off level and a back-off counter value for node assignment satisfying a probability distribution function having the form
$${p}_{i , 0} = \frac{c}{{ρ}^{{ω}_{0} {2}^{i} - 1}} for i ∈ ( 0 , m )$$
$${p}_{i , k} = \frac{c}{{ρ}^{{ω}_{0} {2}^{i} - k}} for k ∈ ( 1 , {ω}_{0} {2}^{i} - 1 ) , i ∈ ( 0 , m )$$
where ρ>1, and c is the normalization constant, and is obtained from
$${\sum }_{k = 0}^{{ω}_{0} {2}^{i} - 1} {p}_{ik} = 1.$$

11. The machine readable storage of claim 9, wherein the assignment step comprises the step of assigning the node to a back-off state associated with the computed back-off level and back-off counter value satisfying a non-uniform probability distribution function.
